(19) United States
(12) Patent Application Publication
(10) Pub. No.: US 2005/0134625 A1
(43) Pub. Date: Jun. 23, 2005

(54) Printing system, printer host and printing program product

(76) Inventor: Eiji Kubota, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/938,123

(22) Filed: Sep. 10, 2004

(30) Foreign Application Priority Data
Sep. 11, 2003 (JP) 2003-319686

(51) Int. Cl. B41J 29/393

(52) U.S. Cl. 347/19

(57) ABSTRACT

A printing system for printing on a label of a record medium performs printing in one of at least two printing modes, to improve usability in high quality printing. The printing system comprises a means for displaying a print set-up screen for receiving print conditions of an image to be printed, the print set-up screen being provided with an area for designating a printing mode for performing higher quality printing, and a means for displaying a list of record media considered to be applicable with printing under printing mode for performing higher quality printing.

### BACKGROUND OF THE INVENTION

The present invention relates to a printing system, and in particular to a printing system for printing on a disk type record medium.

Printers that can print directly on a label surface of a disk type record medium, for example, a CD-R (CD Recordable) or a DVD-R (DVD Recordable), have come into practical use.

Also, label printing application software is used practically. Label printing application software supports generation and editing of an image to be printed on a label and setting of print conditions, and so on, on a printer host that controls such a printer.

Record media (such as CD-R) suitable for label printings are supplied in the market from various manufacturers, and generally, the label surfaces of these media are provided with white coatings to enhance fixing ability of the print medium such as ink or the like and for improved color expression.

As such coating, each manufacturer or each product employs different material or a different coating method or the like, and thus, each coating is different in congeniality with ink or the like used for printing. As a result, it is possible that some record media can be printed beautifully using ink, while that ink cannot be fixed well on other record media.

### SUMMARY OF THE INVENTION

In a printing system comprising a printer and a printer host, usually a user can choose a high quality printing mode or a standard printing mode, according to his preference. In the high quality mode, a high quality print result can be obtained although it takes a longer time. On the other hand, in the standard mode, print time is shorter although a print result becomes coarser in comparison with the high quality mode.

Printing in the higher quality mode consumes a greater amount of ink than printing in the standard mode. Thus, in the case of using a medium having poor congeniality with ink or the like used for printing, printing in the high quality mode may result in blurring of the ink or the like.

On the other hand, it is possible that printing in the high quality mode gives a high quality print result when a medium having good congeniality with ink or the like is used (hereinafter, such a medium will be referred to as a “high quality print applicable medium”).

However, it is difficult for a user to judge whether a record medium such as a CD-R to be printed is a high quality print applicable medium or not. Thus, it is convenient if a user can make this judgment easily. Further, it is convenient if printing in the high quality mode can be designated easily in the case where a medium to be printed is a high quality print applicable medium.

An object of the present invention is to offer improved usage for high quality printing by a printing system used for printing a label of a record medium.

To solve this problem, a first mode of the present invention provides a program product for a computer to perform printing, the program when executed by the computer renders the computer to generate an image data for a printer to print on a label of a record medium, wherein
the program executes the computer to perform:
a processing for displaying a print set-up screen for receiving conditions for the printing of an image to be printed, the print set-up screen provides an area for designating a higher quality printing mode; and
a processing for displaying a list of record media considered to be applicable with printing under the higher quality printing mode.

According to the present invention, a user can easily confirm whether a record medium to be used in printing is applicable with high quality printing.

It is preferable that the above-mentioned list can be acquired through a computer network. Then, a user can obtain the newest information.

Further, a second mode of the present invention provides a program product for a computer to perform printing, the program when executed by the computer renders the computer to generate an image data for a printer to print on a label of a record medium, wherein the program renders the computer to execute:
a processing for displaying a print set-up screen for receiving conditions for the printing of an image to be printed which provides an area for displaying selections corresponding to printing in higher quality printing mode and selections corresponding to printing in other printing modes in a selectable manner; and
a processing for outputting information corresponding to the printing mode selected, together with the generated image data.

According to the present invention, a user can designate high quality printing by simple operation.

Further, the print set-up screen may preferably provide an area for displaying an indication corresponding to printing mode for printing in a higher quality, in a selectable manner.

Then, a user can designate high quality printing by either operation.

In that case, it is preferable that, in the area in which the selection corresponding to the printing mode for performing higher quality printing and the selection corresponding to the other printing modes are displayed in the selectable manner and in the area in which the above-mentioned indication corresponding to the printing mode for performing higher quality printing is displayed in a designative manner, selection of the choice corresponding to the printing mode of performing higher quality printing and designation of the indication corresponding to the printing mode for performing higher quality printing are interlocked with each other.

Further, it is preferable that the computer further executes processing for notifying a warning when printing is to be performed in the printing mode for performing higher quality printing. This is because a record medium printed under high quality printing requires careful handling compared to being printed under standard printing.

The present invention can be applied effectively to an ink-jet printer. This is because finish of the print using ink is greatly affected by the coating on the label surface of the record medium, and further, the ink jetted out on the coating of the label surface requires more time before drying up.

In detail, the above-mentioned warning may include a message that ink should be dried sufficiently and/or the record medium should not be driven before the ink is dried up.

### BRIEF DESCRIPTION OF THE DRAWINGS

FIG. 1 is a block diagram showing overall configuration of the present invention;

FIG. 2 is a block diagram for explaining overall hardware configuration of a printing system;

FIG. 3 is a view showing overall construction of a printer 10 seen from above;

FIG. 4 is a block diagram showing a functional configuration of the printing system;

FIG. 5 is a view showing an example of a print set-up screen;

FIG. 6 is a view showing an example of a high quality print applicable CD/DVD list display screen; and

FIG. 7 is a view showing an example of a warning notification screen.

### DETAILED DESCRIPTION OF THE PREFERRED EMBODIMENTS

Embodiments of the present invention will be described hereinafter with reference to accompanying figures.

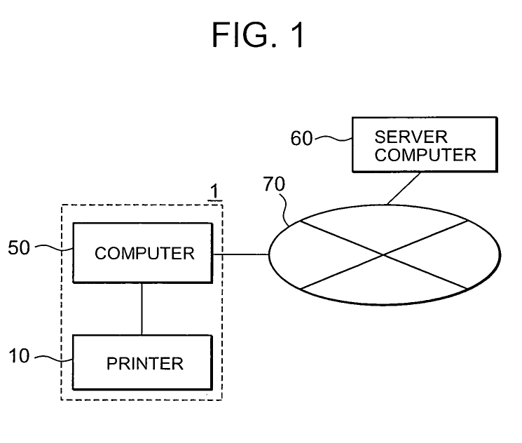

FIG. 1 is a block diagram showing overall configuration of the present invention. A printing system 1, which comprises a computer 50 and a printer 10, is connected to a computer network, for example, the Internet 70, so that various services provided on the Internet 70, for example, browsing of Web pages and sending/receiving electronic information can be used.

The Internet 70 is connected to a server computer 60 which provides electronic information, for example, providing services such as providing Web pages, sending of files, and the like. In the present embodiment, it is preferable that a manufacturer or a service agent of the printer 10 provides electronic information through the server computer 60. Contents of electronic information provided by the server computer 60 will be described later.

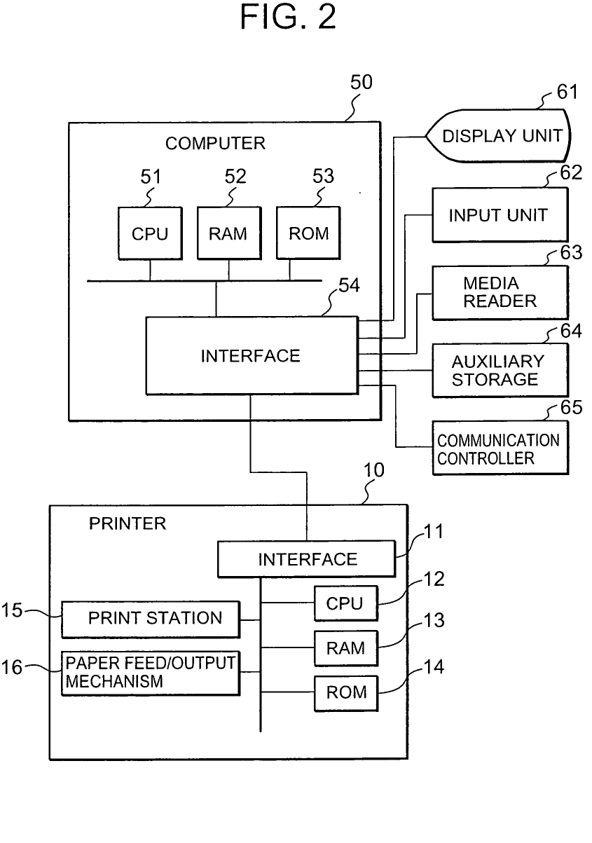

FIG. 2 is a block diagram showing overall hardware configuration of the printing system 1 comprising the computer 50 and the printer 10.

As shown in the figure, the printing system comprises the computer 50, which performs various processes of applications and print processes of a printer driver, and the disk type record medium print applicable printer 10 (hereinafter, also simply referred to as the printer 10) connected to the computer 50. In the present embodiment, the computer 50 functions as a printer host that generates print data and sends the print data to the printer 10. On the other hand, the printer 10 performs printing based on print data sent from the computer 50. The printer 10 has a function of printing a label surface of a disk type record medium such as a CD-R, a DVD-R, or the like in addition to printing on paper of regular sizes, etc. A description for printing on a label surface of the CD-R, for instance, is presented hereinafter.

The computer 50 comprises: a CPU (Central Processing Unit) 51 which performs processing based on various programs; a RAM (Random Access Memory) 52 which temporarily stores data, programs, and the like; a ROM (Read Only Memory) 53 which previously stores in a nonvolatile manner, various data for controlling the computer 50 and programs for start-up execution, and the like; and an interface 54 which manages sending and receiving data to and from peripheral devices such as the connected printer 10.

Further, the computer 50 is connected to a display unit 61 such as a color display, an input unit 62 such as a mouse, a keyboard, or the like, a media reader 63 for reading data from a record medium such as a CD-ROM, a built-in or external auxiliary storage 64, and a communication controller 65 for connecting with a computer network such as the Internet.

The printer 10 is, for example, an ink-jet color printer. An ink-jet color printer is provided with a plurality of ink cartridges each having a box member filled with ink and performs printing by blowing the inks through a print head onto a print medium such as printing paper, a CD-R, or the like.

The printer 10 comprises: an interface 11 which manages communication with (such as reception of data from) the computer 50; a CPU 12 which executes processing based on various programs and print data; a RAM 13 which temporarily stores print data and the like; a ROM 14 which previously stores, in a nonvolatile manner, various data for controlling the printer 10, various programs, and the like; a print station 15 comprising a print head for jetting out ink, a carriage drive for driving a carriage mounted with the print head, and the like; and a paper feed/output mechanism 16.

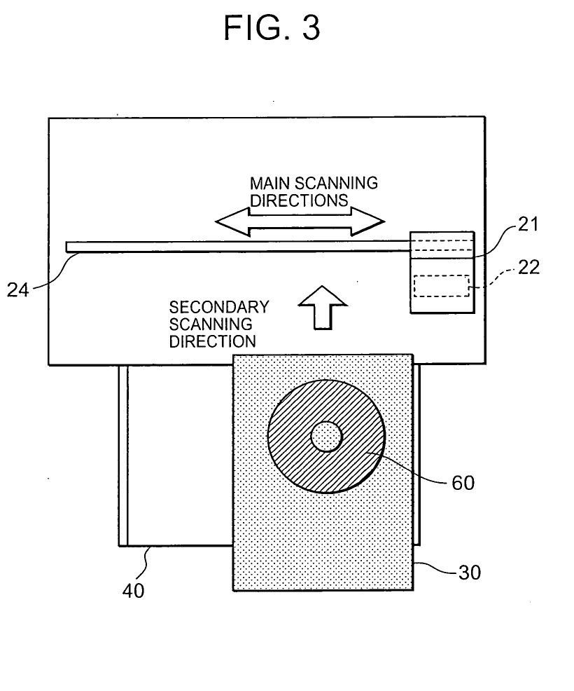

FIG. 3, describes an overall print station 15 and the paper feed/output mechanism 16 in the case where the printer 10 of the present embodiment prints a CD-R label.

FIG. 3 shows overall construction of the printer 10 seen from above. In the case of printing a CD-R label, a CD-R 60 is set on a CD/DVD tray 30. Then, the CD/DVD tray 30 is inserted into the main body of the printer 10 along a guide 40 provided in the main body of the printer 10.

The printer 10 comprises: a carriage 21 on which a plurality of ink cartridges are mounted; an ink-jet print head 22 supported by the carriage 21; a supporting rod 24 which supports the carriage 21 reciprocating in main scanning directions; and a feed mechanism (not shown) for feeding the CD/DVD tray 30 in a secondary scanning direction and discharging the CD/DVD tray 30 outside the printer 10.

The carriage 21, which is reciprocated by a carriage motor not shown, is attached with the ink-jet print head 22 on the side facing the CD/DVD tray 30. The print head 22 receives supply of ink from the ink cartridges, and jets out ink drops to form dots on a label surface of a CD-R 60 mounted on the CD/DVD tray 30 as the carriage 21 moves, so that images, characters and the like are printed on the label surface of the CD-R 60.

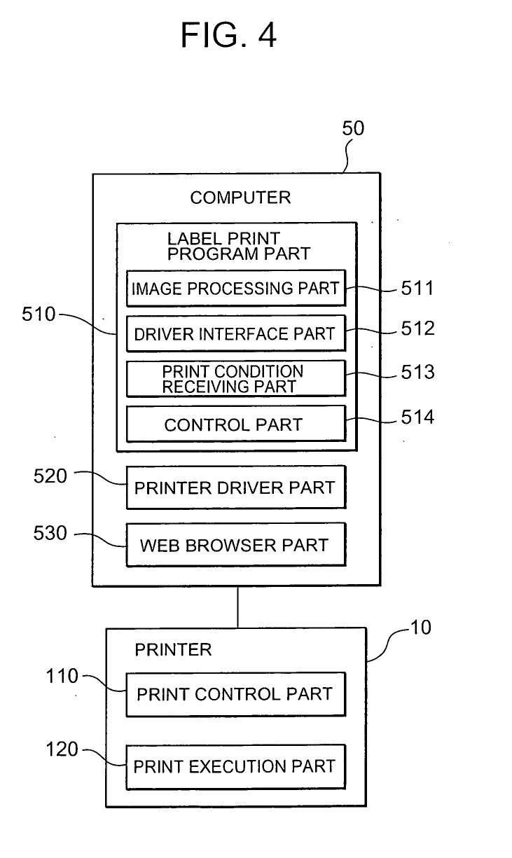

Next, with reference to functional block diagram in FIG. 4, a functional configuration realized by the above-described printing system in the computer 50 and the printer 10 will be described.

As shown in the figure, a label print program part 510, a printer driver part 520, and a Web browser part 530 are installed on the computer 50.

The label print program part 510 performs processing for assisting setting of print conditions and generation and edition of an image at the time when a CD-R label is printed in the present printing system. Further, at the time of receiving the setting of print conditions, the label print program part 510 performs processing for referring to and displaying a list of high quality print applicable media. Here, the list is stored inside or outside the computer 50.

To these ends, the label print program part 510 includes an image processing part 511 having image generating/editing functions, a driver interface part 512 having an interface function with the printer driver part 520, a print condition receiving part 513, and a control part 514 which controls various processes in the label print program part 510.

The label print program part 510 is loaded on the computer 50 when the CPU 51 executes a label print application program loaded onto the RAM 52.

The printer driver part 520 has functions of reading image data generated and set by the label print program part 510, converting the image data into print data of a format that the printer 10 can interpret, and sending the print data to the printer 10 through the interface 54. In the process of conversion into print data, practically: a rasterizing process in which read image data are expanded into image data constituted of dots;
a half-toning processing in which color conversion and halftone processing are performed with respect to the image data; and a conversion processing in which the image data processed is converted into print image, are performed.

In converting image data into print data, the printer driver part 520 can selectively perform the conversion into print data of at least two modes based on the print set-up, namely, a high quality mode in which high quality printing is performed and an standard mode in which standard printing is performed. In the high quality mode, printing is performed using a greater amount of ink in comparison with printing in the standard mode, so that a print result of higher quality can be obtained. Thus, printing in the high quality mode requires much time for ink to dry up, in comparison with printing in the standard mode.

The printer driver part 520 is loaded on the computer 50 when the CPU 51 executes a printer driver program loaded onto the RAM 52.

The Web browser part 530 performs processing for browsing Web pages provided on the Internet 70, for example. The Web browser part 530 is loaded on the computer 50 when the CPU 51 executes general purpose Web browser software.

The label print application program or the printer driver program can be distributed in the market by being recorded in a portable record medium such as a CD-ROM, for example. Then, reading this record medium by the media reader 63, the program can be loaded onto the computer 50. Or, for example, these programs can be loaded onto the computer 50 through the Internet 70 also.

As seen in FIG. 4, a print control part 110 and a print execution part 120 are loaded on the printer 10.

The print control part 110 interprets print data sent from the computer 50, and performs control operation in order that the printer 10 performs printing based on the print data. The print control part 110 is loaded on the printer 10 when the CPU 12 executes processing based on programs and print data read into the RAM 13.

The print execution part 120 executes printing of a label of a CD-R 60 according to an instruction of the print control part 110. The print execution part 120 is loaded on the printer 10 when the print station 15 and the feed/output mechanism 16 perform respective processes.

Next, processing in the label print program part 510 will be described.

A user can use the image processing part 511 of the label print program 510 to generate and edit an image to be printed in a print area. The image processing part 511 displays the image corresponding to a label area of a CD-R and receives instructions related to generation and edition of the image from the user. Conventional techniques may be used for such image processing, and thus, description of the image processing is omitted here.

When the image to print is obtained using the image processing part 511, the user can perform label printing. At the time of printing, print conditions can be set.

In the processing of receiving the setting of print conditions, the print condition receiving part 513 of the label print program 510 displays a print set-up screen.

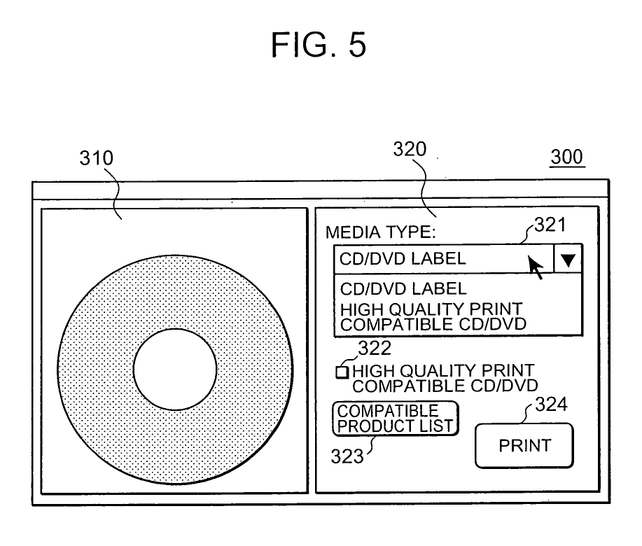

FIG. 5 is a view showing an example of the print set-up screen. As shown in the figure, the print set-up screen 300 has an area 310 for displaying a generated and edited image and a print set-up area 320 for setting print conditions.

In the print set-up area 320, it is possible to select a print medium by a media type selection menu 321 of a so-called pull-down menu form. In the present embodiment, either a “CD/DVD label” or a “high quality print applicable CD/DVD label” can be selected as a print medium. In the case where the user uses a print medium such as a high quality print applicable CD, and wishes to perform high quality printing, the user selects the “high quality print applicable CD/DVD label” in the media type selection menu 321 to obtain a higher quality print result in comparison with the case of selecting the “CD/DVD label”. Namely, when the “high quality print applicable CD/DVD label” is selected, printing is performed in the high quality mode. On the other hand, when the “CD/DVD label” is selected, printing is performed in the standard mode.

Further, in the print set-up screen 300, separate from selection utilizing the pull-down menu form, it is possible to input a check into a so-called check box to designate high quality printing. To this end, the print set-up screen has a “high quality print applicable CD/DVD” check box 322.

Here, the media type selection menu 321 and the “high quality print applicable CD/DVD” check box 322 are interlocked with each other such that selection or designation/cancellation operation in one area automatically leads to designation/cancellation or selection in the other area.

Thus, according to the present embodiment, simple operation can designate execution or non-execution of high quality printing with respect to printing of a label of a CD-R or the like.

However, it is generally difficult for a user to judge whether a print medium to be printed is applicable with high quality printing.

For this reason, the print set-up screen 300 is provided with a “applicable product list” button 323. When a click of the “applicable product list” button 323 is received, the print condition receiving part 513 displays a list of products that the manufacturer or the service agent of the printer 10 has authorized as the medium applicable with high quality printing, among CD-Rs and the like on the market.

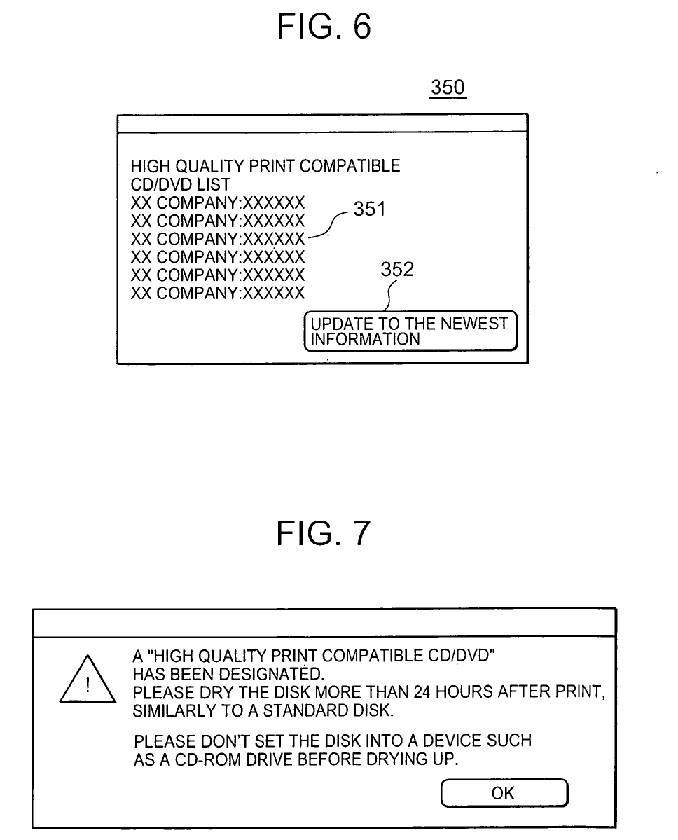

FIG. 6 is a view showing an example of a high quality print applicable CD/DVD list display screen.

For example, this list can be managed by the label print program part 510 and stored previously inside the computer 50. Further, to acquire the newest information, the list may be acquired by communicating with the server computer 60 through the Internet 70, for example. To this end, the high quality print applicable CD/DVD list display screen 350 is provided with an “update to the newest information” button 352. It is imposed that the manufacturer or the service agent of the printer 10 provides the newest information on products that have been authorized as the medium applicable with high quality printing.

Or, the list may not be provided in the computer 50. In that case, it is possible that, when a click of the “applicable product list” button 323 is received in the print set-up screen 300, then the print condition receiving part 513 launches the Web browser part 530 to access a Web page to be presented by the server computer 60 and to display the list.

The user can check whether the print medium to be printed is registered in the list. When the print medium is registered in the list, the user can select the “high quality print applicable CD/DVD” to obtain a high quality label print result.

Or, it is possible to send a trade name of the print medium or a code or the like attached to the product to the server computer 60. Then, the server computer 60 may judge whether the print medium is applicable with high quality printing, and returns a judgment result. In that case, based on the judgment result, the “high quality print applicable CD/DVD” in the print set-up screen 300 may be automatically selected.

When a click of a “print” button 324 is received in the print set-up screen 300, the control part 514 judges whether the “high quality print applicable CD/DVD” is designated or not.

As a result, in the case where the “high quality print applicable CD/DVD” is designated, then the label print program part 510 notifies a warning that the user should not use the record medium until ink dries sufficiently. This is because high quality printing (i.e., printing in the high quality mode) uses a greater amount of ink in comparison with printing in the standard mode, and thus requires much time for the ink to dry up. The warning is notified by displaying a screen such as shown in FIG. 7, for example. In this example, a warning is indicated to the user by displaying “High quality print applicable CD/DVD” has been designated. Please leave the disk more than 24 hours after being printed for drying up, in the same manner with a standard disk. Please don't set the disk into a device such as a CD-ROM drive before being dried up.” Of course, contents of the warning are not limited thereto.

On the other hand, when the “high quality print applicable CD/DVD” is not designated, or after the above warning is notified, the driver interface part 512 of the label print program part 510 outputs the generated and edited image data together with the contents of the setting in the print set-up area (namely, designation of the high quality mode or the standard mode based on designation or non-designation of the “high quality print applicable CD/DVD”), to the printer driver part 520. At that time, output may be performed by an operating system (not shown) of the computer 50.

Receiving the image data and the designation of the high quality mode or the standard mode from the label print program part 510, the printer driver part 520 generates print data based on the received image data. At that time, image data generation processing is performed according to the designated high quality mode or standard mode. Then, generated image data is outputted to the printer 10. Accordingly, label printing is performed when the printer 10 mounted with the medium such as a CD-R performs printing based on the print data.

In the above example, as a method of notifying a warning, a warning message is displayed. The present invention is not limited to this, and a warning may be notified by sound or using another method. Further, it may be arranged such that, after notification of a warning, a user can stop the label printing.

Recently, record media such as CD, DVD are not limited to circular shape, but various plate types including a record medium in a shape of card, trapezoid have been brought into practical use. The present invention can be applied to a record medium of any shape.

1. A printing system capable of printing in at least two modes on a label of a record medium, comprising:
a means for displaying a print set-up screen for receiving conditions for the printing of an image to be printed, the print set-up screen provides an area for designating a higher quality printing mode; and
a means for displaying a list of record media considered to be applicable with printing under the higher quality printing mode.

2. A printing system capable of printing in at least two modes on a label of a record medium, comprising a means for displaying a print set-up screen for receiving conditions for the printing of an image to be printed, wherein
the print set-up screen provides an area for displaying selections corresponding to printing in higher quality printing mode and selections corresponding to printing in other printing modes in a selectable manner.

3. A printer host that sends print data to a printer for printing on a label of a record medium, comprising:
a means for generating print data for generating print data based on at least two printing modes;
a means for displaying a print set-up screen for receiving conditions for the printing of an image to be printed, the print set-up screen provides an area for designating a higher quality printing mode; and
a means for displaying a list of record media considered to be applicable with printing under the higher quality printing mode.

4. A printer host that sends print data to a printer for printing on a label of a record medium,
said printer host comprises:
a means for generating print data for generating print data based on at least two printing modes; and
a means for displaying a print set-up screen for receiving conditions for the printing of an image to be printed;
wherein
the print set-up screen provides an area for displaying selections corresponding to printing in higher quality printing mode and selections corresponding to printing in other printing modes in a selectable manner.

5. A program product for a computer to perform printing, the program when executed by the computer renders the computer to generate an image data for a printer to print on a label of a record medium, wherein
the program executes the computer to perform:
a processing for displaying a print set-up screen for receiving conditions for the printing of an image to be printed, the print set-up screen provides an area for designating a higher quality printing mode; and
processing for displaying a list of record media considered to be applicable with printing under the higher quality printing mode.

6. A program product according to claim 5, wherein:
the program renders the computer to further execute a processing for acquiring information of said list through a computer network.

7. A program product for a computer to perform printing, the program when executed by the computer renders the computer to generate an image data for a printer to print on a label of a record medium, wherein
the program renders the computer to execute:
a processing for displaying a print set-up screen for receiving conditions for the printing of an image to be printed which provides an area for displaying selections corresponding to printing in higher quality printing mode and selections corresponding to printing in other printing modes in a selectable manner; and
a processing for outputting information corresponding to the printing mode selected, together with the generated image data.

8. A program product according to claim 7, wherein:
the print set-up screen further provides an area for displaying a display corresponding to printing in higher quality printing mode in a designative manner.

9. A program product according to claim 8, wherein:
in the area for displaying selections corresponding to printing in higher quality printing mode and selections corresponding to printing in other printing modes in a selectable manner and in the area for displaying selections corresponding to printing in higher quality printing mode in a selectable manner, the selection corresponding to printing mode for performing higher quality printing and the designation for displaying a display corresponding to printing in higher quality printing mode are interlocked with each other.

10. A program product according to one of claim 5 and 7, wherein:
the program further executes the computer to perform processing for notifying a warning when printing is to be performed under the higher quality printing mode.

11. A program product according to one of claim 5 and 7, wherein:
said printer is an ink-jet printer.

12. A program product according to claim 11, wherein:
said warning includes a message to sufficiently dry up the ink and/or said record medium should not be driven before the ink dries up.
